(19) United States
(12) Patent Application Publication
(10) Pub. No.: US 2004/0157195 A1
(43) Pub. Date: Aug. 12, 2004

(54) Methods and apparatus for facilitating conceptual development

(76) Inventor: Roger Andresen, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/365,301

(22) Filed: Feb. 12, 2003

(51) Int. Cl. G09B 25/06

(52) U.S. Cl. 434/130

(57) ABSTRACT

Methods, teaching apparatus, and educational puzzles for facilitating conceptual development are provided. One embodiment is a teaching apparatus comprising: a lenticular material having an array of lenticules with cylindrical lenses; and a lenticular image associated with the lenticular material and designed to teach an educational concept, the lenticular image comprising a first image corresponding to a first category related to the educational concept and a second image corresponding to a second category related to the educational concept, the first and second categories selected such that relative movement between the teaching apparatus and a viewer enables the viewer to easily perceive the association between the first and second images and thereby learn the educational concept.

### FIELD OF THE INVENTION

The present invention is generally related to conceptual development, and more particularly is related to methods and apparatus for facilitating conceptual development.

### BACKGROUND

Jean Piaget, one of the founders of cognitive and conceptual development, was quoted as saying in 1952: “Knowing is a product of continuous interaction between the person and the environment.”

Educators and parents continue to strive to develop new ways to effectively teach children a variety of different subjects, and psychologists continue to study the processes involved in learning. Many of the complex processes involved in learning include perception, cognition, development of concepts, and categorization. Psychologists and cognitive scientists generally refer to perception and cognition as the manner in which an individual transforms, organizes, stores, and uses information arising from the individual's environment in sense, data, or memory. In more general terms, perception and cognition refer to the manner in which an individual interacts with the world to “learn”. The Handbook of Perception and Cognition 2^{nd} Edition: Cognitive Science, Academic Press, 1999, by Benjamin Martin Bly and David E. Rumelhart, which is hereby incorporated by reference in its entirety, provides a detailed analysis of the fields of perception, cognition, learning, conceptual development, categorization, etc.

In general, the study of concepts and categorization involves the most fundamental processes concerning the interaction of an individual's mind and the world. Therefore, as known in the art, the ability of children and adults to develop or learn concepts is largely dependent on their ability to categorize. The term “concept” generally includes the mental representation of a category serving multiple functions, one of which is to allow for the determination of whether or not something belongs to a class. A “category” includes the set of entities picked out by the concept. Concepts may serve multiple functions, including numerous possible taxonomies, such as categorization, understanding, inferences, explanation and reasoning, learning, communication, and combination. The Handbook of Perception and Cognition 2 ^{nd} Edition: Perception and Cognition at Century's End, Academic Press, 1998, by Julian Hochberg and The Big Book of Concepts, The MIT Press, 2002, by Gregory L. Murphy, each of which are hereby incorporated by reference in their entirety, provide a detailed analysis of concepts and categorization and their fundamental role in the learning process.

With this background in mind, currently, there are a number of teaching devices that have been developed to facilitate the conceptual development of children, and to a lesser extent adults, and to enable these individuals to learn various concepts related to a variety of different subjects. Although each of these current devices has a noble purpose, they vary in their ability to effectively achieve this purpose. As most educators and parents are aware, it can be very difficult to inspire individuals, particularly young children, to engage in the learning process. For example, there are a variety of types of educational puzzles and other teaching devices that are designed to teach and, at the same time, entertain. Although current methods can, and do, inspire individuals to learn, or at least make it more fun to learn, there continues to be a need for new, entertaining, and more exciting methods for teaching educational subjects.

### SUMMARY

The present invention provides methods, teaching apparatus, and educational puzzles for facilitating conceptual development.

One embodiment is a teaching apparatus comprising: a lenticular material having an array of lenticules with cylindrical lenses; and a lenticular image associated with the lenticular material and designed to teach an educational concept, the lenticular image comprising a first image corresponding to a first category related to the educational concept and a second image corresponding to a second category related to the educational concept, the first and second categories selected such that relative movement between the teaching apparatus and a viewer enables the viewer to easily perceive the association between the first and second images and thereby learn the educational concept.

Another embodiment comprises an educational puzzle. One such educational puzzle comprises a plurality of puzzle pieces formed from a lenticular material having an array of lenticules with cylindrical lenses and a lenticular image associated with the lenticular material and designed to teach an educational concept, the lenticular image comprising a first image corresponding to a first category related to the educational concept and a second image corresponding to a second category related to the educational concept, the first and second categories selected such that relative movement between the teaching apparatus and a viewer enables the viewer to easily perceive the association between the first and second images and thereby learn the educational concept.

A further embodiment comprises a method of making an educational puzzle designed to teach an educational concept. One such method comprises the steps of: selecting a first image to include in a lenticular image, the first image corresponding to a first category related to an educational concept; selecting a second image to include in the lenticular image, the second image associated with the first image and corresponding to a second category related to the educational concept; and creating a lenticular assembly comprising a lenticular material having an array of lenticules with cylindrical lenses and a lenticular image based on the first image and the second image such that relative movement between the lenticular image and a viewer enables the viewer to easily perceive the association between the first and second images and thereby learn the educational concept.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an exemplary method for creating a lenticular image to be used in a teaching apparatus according to the present invention.

FIG. 2 is a cross-sectional view of an embodiment of a teaching apparatus according to the present invention, which may employ the lenticular image of FIG. 1.

FIG. 3 is a block diagram illustrating an exemplary method for creating a lenticular image to be used in the teaching apparatus of FIG. 2 for teaching various aspects of the human anatomy.

FIG. 4 is a block diagram illustrating another exemplary method for creating a lenticular image to be used in the teaching apparatus of FIG. 2 for teaching the chronological history of the United States.

FIG. 5 is a cross-sectional view of an embodiment of an educational puzzle according to the present invention, which may employ the lenticular images of FIGS. 1, 3, and 4.

FIG. 6 is a top view of the educational puzzle of FIG. 5.

FIG. 7 is a flow chart illustrating one of a number of embodiments of a method according to the present invention for making the educational puzzle of FIGS. 5 and 6.

FIG. 8 is a perspective view of another embodiment of an educational puzzle, according to the present invention, illustrating the oceans and continents of the world at a first point-of-view.

FIG. 9 is a perspective view, at a second point-of-view, of the educational puzzle of FIG. 8 illustrating the countries in each continent.

FIG. 10 is a perspective view of another embodiment of an educational puzzle, according to the present invention, illustrating the states in the United States, state names and capitals, and various landmarks at a first point-of-view.

FIG. 11 is a perspective view, at a second point-of-view, of the educational puzzle of FIG. 10 illustrating the state nicknames.

FIG. 12 is a perspective view of a further embodiment of an educational puzzle, according to the present invention, illustrating the numerals 1-12 at a first point-of-view.

FIG. 13 is a perspective view, at a second point-of-view, of the educational puzzle of FIG. 12 illustrating the spelling of the numerals 1-12.

FIG. 14 is a perspective view, at a third point-of-view, of the educational puzzle of FIG. 12 illustrating a quantity of objects corresponding to each numeral.

### DETAILED DESCRIPTION

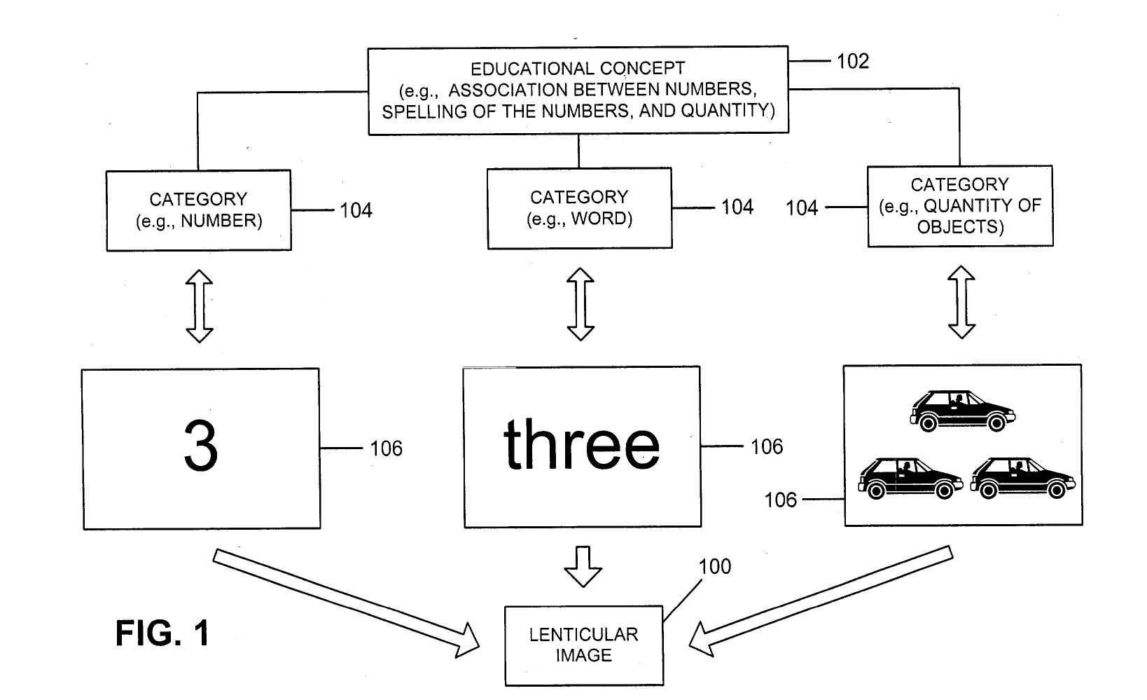

Various exemplary embodiments of methods, teaching apparatus, and educational puzzles, according to the present invention, will be described in detail with respect to FIGS. 1-14.

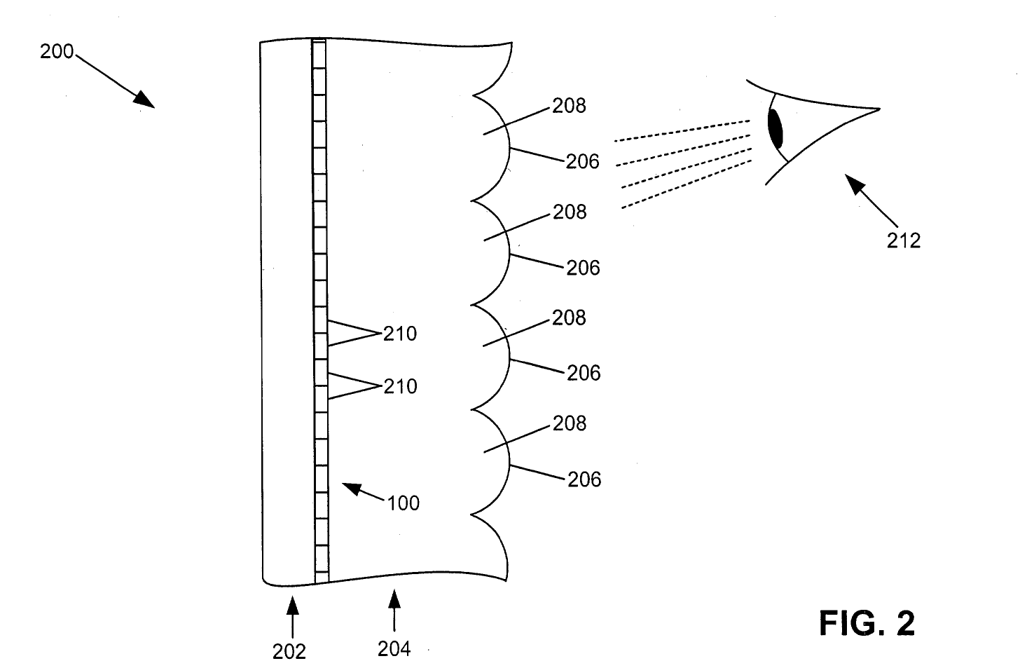

FIG. 1 illustrates an exemplary method for creating a lenticular image 100, according to the present invention, which may be used in various embodiments of teaching apparatus, educational puzzles, and other similar products. Lenticular image 100 is described in further detail with respect to FIG. 2. Nonetheless, as known in the art, a lenticular image may be created by combining, encoding, interlacing, etc. two or more digital images into a single composite image to be viewed through a lenticular material (e.g., an array of lenticules with cylindrical lenses). The combination of the lenticular image and the lenticular material may be referred to as a lenticular assembly. When viewing a lenticular image in this manner, a viewer may alternate between viewing each of the underlying digital images by adjusting the position of the lenticular image relative to the viewer (i.e., adjusting the point-of-view). In other words, a viewer may, for example, tilt the lenticular assembly back and forth (or side to side) to successively view the underlying digital images.

As illustrated in the block diagram of FIG. 1, lenticular image 100 according to the present invention may be designed, created, etc. to convey or teach any of a variety of types of educational concepts 102. Lenticular image 100 enables a viewer to successively view two or more digital images 106 that are selected to correspond to a particular category 104 related to educational concept 102. One of ordinary skill in the art will appreciate that, as digital images 106 are viewed by adjusting the relative position of a lenticular assembly including lenticular image 100, the viewer may be able to quickly and easily perceive the association between the respective categories 104. In this manner, lenticular image 100 may facilitate the viewer's ability to learn educational concept 102.

Various examples of educational concepts 102 are described in detail below. It should be appreciated, however, that educational concept 102 may be related to any of a variety of types of desirable educational subjects, including geography, science, math, spelling, history, anatomy, biology, alphabets, numbers, etc. Educational concept 102 may be broadly defined, as in the case of a particular educational subject, or narrowly defined to teach a particular association between various categories 104. For example, educational concept 102 may be defined to convey or teach concepts such as opposites (e.g., hot/cold), progression of seasons (e.g., winter, spring, summer, fall), classification of organisms, or nearly any categories of taxonomic hierarchy.

Big Book of Concepts, Handbook of Perception and Cognition 2^{nd} Edition: Perception and Cognition at Century 's End, and Handbook of Perception and Cognition 2^{nd} Edition: Cognitive Science, each of which form a part of this specification, provide additional technical details regarding concepts 102, categories 104, and the processes of conceptual development, learning, etc.

Referring again to FIG. 1, a particular example of lenticular image 100 will be described. In the embodiment illustrated in FIG. 1, lenticular image 100 is designed to illustrate, convey, or teach the association between (1) numbers, (2) the spelling of the numbers, and (3) the quantity associated with the numbers (i.e., collectively, educational concept 102). In this regard, categories 104 may comprise (1) a number, (2) a word spelling of the number, and (3) a quantity of objects associated with the number. Given this design framework for lenticular image 100, three digital images 106 associated with categories 104 may be selected. In this example, digital image 106 corresponding to the category “number” may illustrate the numeral “3”. Digital image 106 corresponding to the category “word” may illustrate the spelling of the numeral “3” (i.e., the word “three”). Digital image 106 corresponding to the category “quantity” may illustrate, for example, three cars.

As known in the art, these three digital images 106 may be combined, encoded, interlaced, etc. to create lenticular image 100. It should be appreciated that any method of creating a composite image may be used. For example, U.S. Pat. Nos. 6,329,987 and 6,414,794, each of which are hereby incorporated by reference in their entirety, describe several common ways to combine digital images 106 to form lenticular image 100.

As described in more detail below, lenticular image 100 may be viewed through a lenticular material (collectively, a lenticular assembly). In operation, a viewer may successively view the “3,” the word “three,” and the graphic of three cars by adjusting the relative position of the lenticular assembly. One of ordinary skill in the art will appreciate that, by easily and quickly viewing each of these images, lenticular image 100 according to the present invention may enable a viewer to more effectively perceive the association between the respective categories 104 to learn the particular educational concept 102.

FIG. 2 illustrates one of a number of embodiments of a teaching apparatus 200, according to the present invention. As illustrated in FIG. 2, teaching apparatus 200 may comprise lenticular material 204 and lenticular image 100. Lenticular material 204 may comprise an array of aligned lenticules 206, with respective cylindrical lenses 208. Lenticular image 100 is associated with lenticular material 204. As known in the art, the process of creating lenticular image 100 from digital images 106 results in a sequence of frames having interleaved strips 210. Each frame is associated with a corresponding lenticule 206. Cylindrical lenses 208 focus to lenticular image 100 and a specific set of strips 210 constituting the frame so that a particular set of strips 210 can be seen at a particular viewing position (i.e., point-of-view) by a viewer 212. As the viewing position changes, for example, by tilting teaching apparatus 200 or by movement of viewer 212 relative to teaching apparatus 200, different frames are seen by viewer 212 (i.e., different digital images 106 are seen). Generally, the number of frames or digital images 106 in lenticular image 100 corresponds to the number of strips 210 behind each lenticule 206. However, it should be appreciated that any number of digital images 106 may be incorporated into lenticular image 100.

It should be appreciated that lenticular image 100 may be an image formed in an image bearing layer (e.g., photosensitive layer) 202 coated on the back of lenticular material 204 by, for example, a laser printer or a contact printer. Lenticular image 100 may also be printed on lenticular material 204 by any well-known technique, such as, for example, thermal printing, ink jet printing; electrophotographic printing, conventional ink printing, etc. Lenticular image 100 may also be formed in a separate element which is then aligned with and laminated to lenticular material 204.

It should be appreciated that lenticules 206 may be oriented in any direction, but in one embodiment are oriented in a horizontal or vertical direction for tilting about their respective axes.

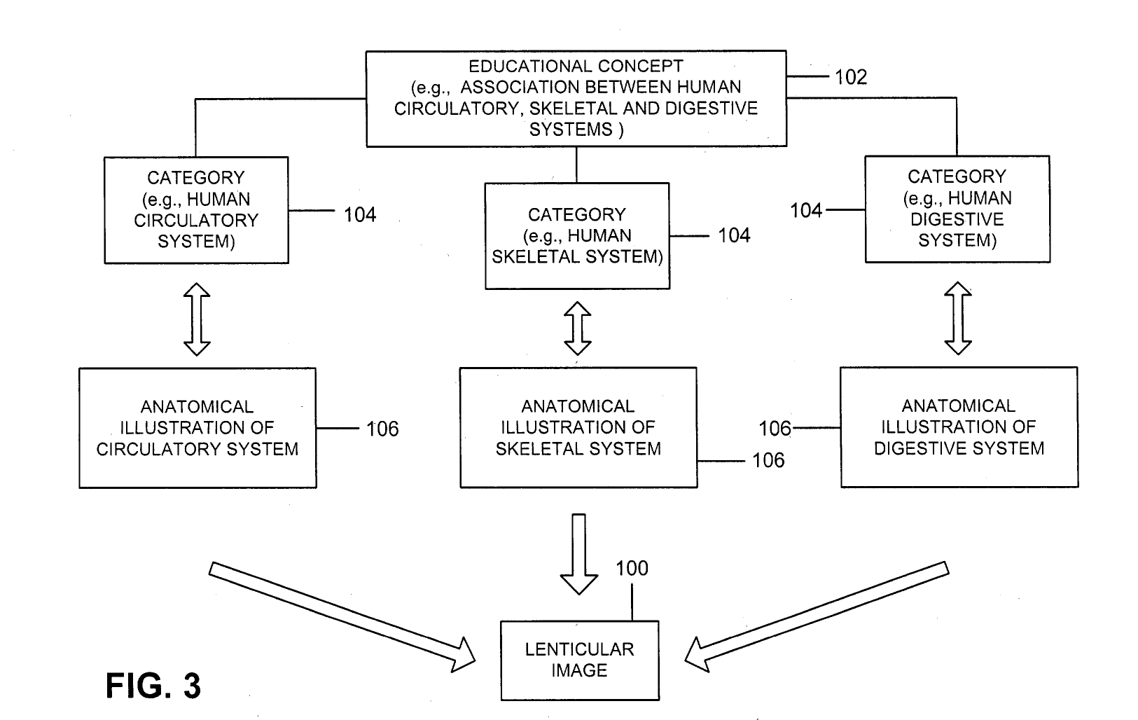

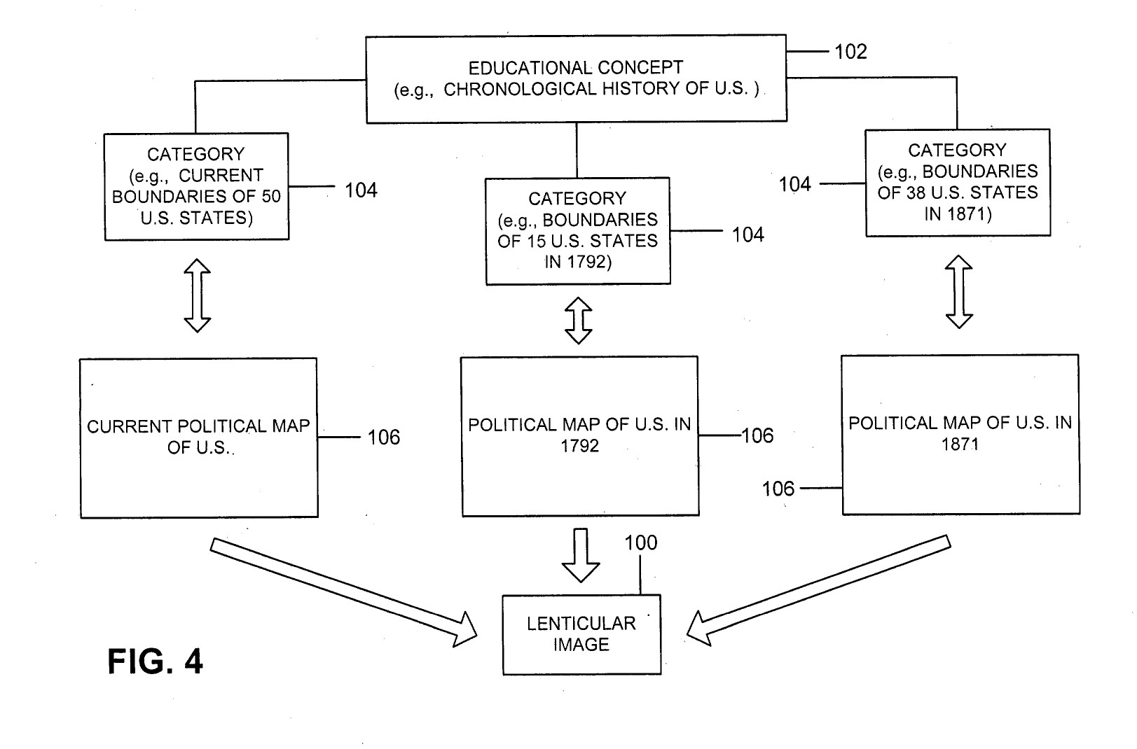

FIGS. 3 and 4 illustrate two additional exemplary embodiments of lenticular image 100, educational concept 102, categories 104, and digital images 106. In the embodiment illustrated in FIG. 3, lenticular image 100 is designed to illustrate, convey, or teach an educational concept related to human anatomy. More specifically, lenticular image 100 is designed to illustrate, convey, or teach the association between the following categories 104: (1) the human circulatory system; (2) the human skeletal system; and (3) the human digestive system (i.e., collectively, educational concept 102). As described above, given this design framework for lenticular image 100, three digital images 106 associated with categories 104 may be selected. In this example, digital images 106 may comprise corresponding anatomical illustrations of the human circulatory, skeletal, and digestive systems.

When incorporated into teaching apparatus 200, a viewer 212 may successively view each of the anatomical illustrations by adjusting the relative position of teaching apparatus 200. One of ordinary skill in the art will appreciate that, by easily and quickly viewing each of these images, lenticular image 100 according to the present invention may enable viewer 212 to more effectively perceive the relative association between the anatomical systems.

In the further embodiment of FIG. 4, lenticular image 100 is designed to illustrate, convey, or teach an educational concept related to the chronological history of the United States of America. More specifically, lenticular image 100 is designed to illustrate, convey, or teach the association between the following categories 104: (1) the current boundaries of the fifty U.S. states; (2) the boundaries of the fifteen U.S. states in 1792; and (3) the boundaries of the thirty eight U.S. states in 1871. (i.e., collectively, educational concept 102). As described above, given this design framework for lenticular image 100, three digital images 106 associated with categories 104 may be selected. In this example, digital images 106 may comprise three political maps of the United Stated illustrating the state boundaries at the respective times in U.S. history.

When incorporated into teaching apparatus 200, a viewer 212 may successively view each of the political maps by adjusting the relative position of teaching apparatus 200. One of ordinary skill in the art will appreciate that, by easily and quickly viewing each of these political maps, lenticular image 100 according to the present invention may enable viewer 212 to more effectively perceive the chronological development of the United States.

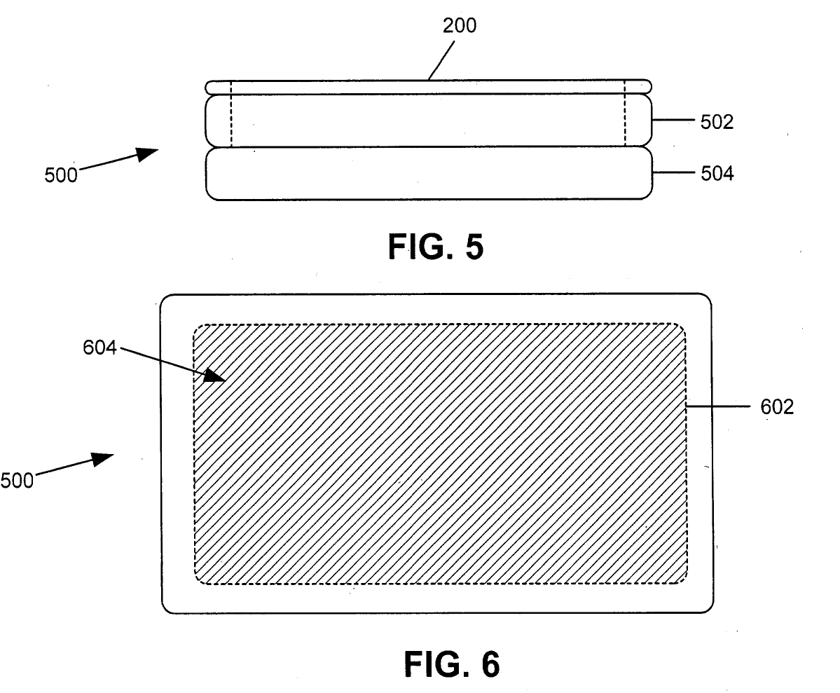

It should be appreciated that lenticular image 100 and teaching apparatus 200, according to the present invention, may be implemented in a variety of applications and incorporated into a variety of different teaching devices. In one of a number of embodiments, teaching apparatus 200 may implemented in an educational puzzle. Referring to FIGS. 5-7, one of a number of embodiments of an educational puzzle 500, according to the present invention, will be described. As illustrated in FIG. 5, educational puzzle 500 may comprise teaching apparatus 200 and two sheets of cardboard, chipboard, etc. Teaching apparatus 200 may be mounted, in any known manner, to the top surface of a top sheet 502 of chipboard. The top sheet 502 may be affixed to a bottom sheet 502 of chipboard.

As illustrated in FIG. 6, in one of a number of embodiments, the sheets of chipboard may be affixed (e.g., glued, fastened, or otherwise attached, etc.) at respective outer peripheral edges 602. In order to create the pieces of educational puzzle 500, a steel diecut may be used to cut an interior portion 604 of the top sheet 502, within the outer peripheral edge 602 where the sheets are affixed (dashed lines in FIGS. 5 and 6). In this manner, the puzzle pieces may be cut out of teaching apparatus 200 and top sheet 502. It should be appreciated that, after the diecut process is. complete, the puzzle pieces may be easily detached, removed, etc. because interior portion 604 of top sheet 502 is not affixed to bottom sheet 504. It should be further appreciated that, when the puzzle pieces are removed, a support frame is created by the recess defined in interior portion 604 of top sheet 502. The support frame may provide a convenient mechanism for retaining the puzzle pieces.

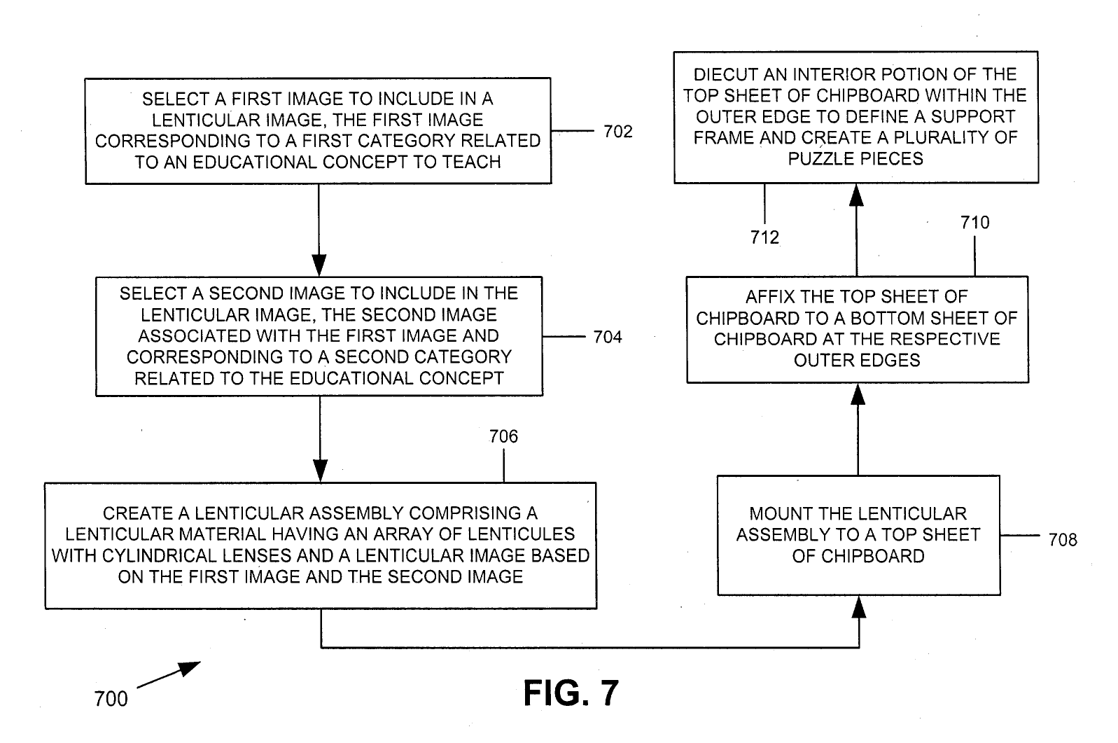

FIG. 7 is flow chart illustrating an exemplary method for making the educational puzzle 500 described above. It should be appreciated, however, that in alternative embodiments the steps represented by blocks need not be performed as discrete steps. Furthermore, the steps represented by blocks may be performed simultaneously and in any desirable order.

One of ordinary skill in the art will appreciate that the pieces of educational puzzle 500 may be created in a variety of alternative ways. For example, two sheets of chipboard need not be used and other cutting devices and methods, such as a jigsaw, may be implemented.

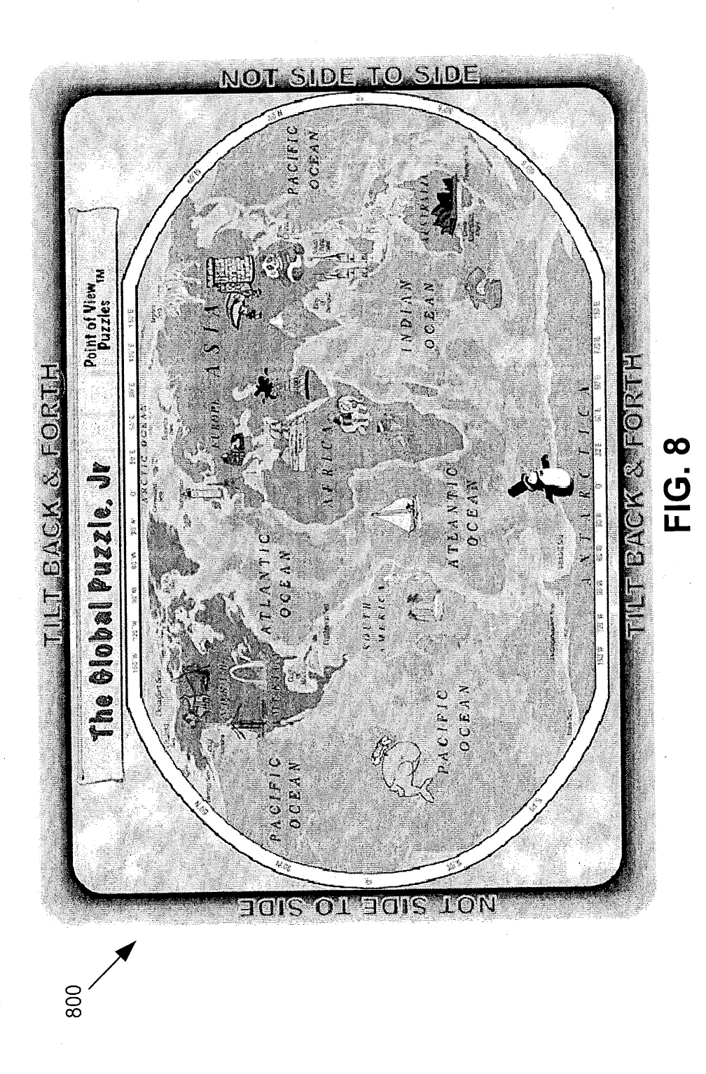

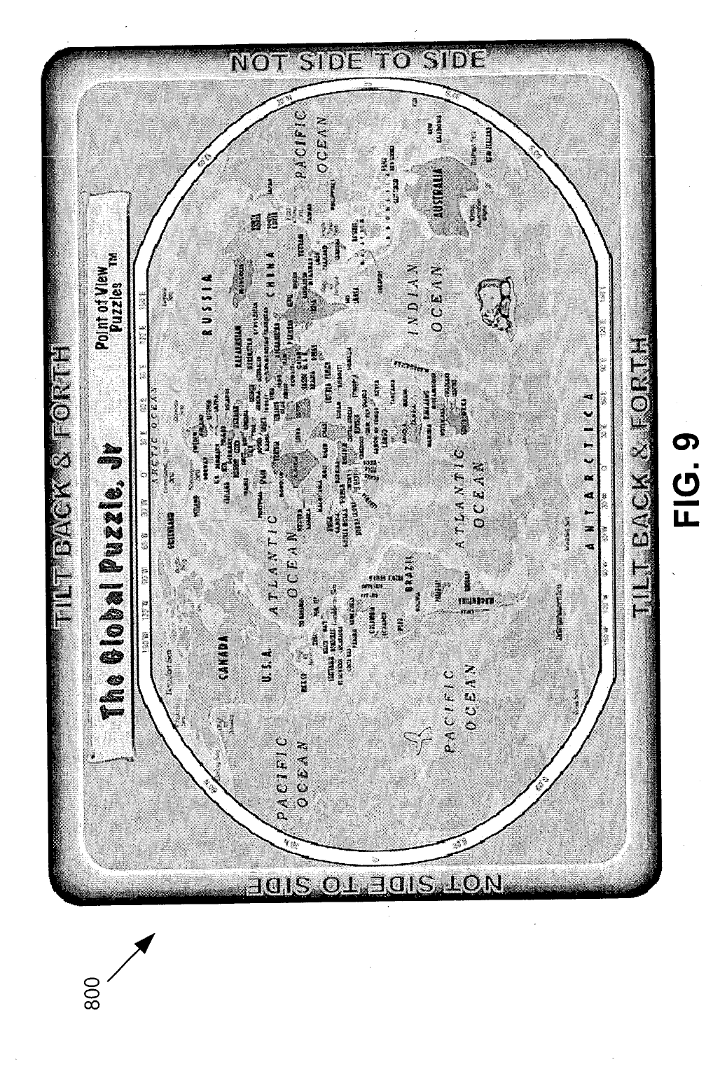

FIGS. 8 and 9 illustrate an alternative embodiment of an educational puzzle 800 according to the present invention. Educational puzzle 800 may be configured as described above with respect to FIGS. 5-7, or in any other known manner. The lenticular image 100 implemented in educational puzzle 800 may be designed to illustrate, convey, or teach an educational concept 102 related to world geography. More specifically, lenticular image 100 may be designed to illustrate, convey, or teach the association between the continents in the world and the countries that comprise each continent (i.e., educational concept 102). As described above, given this design framework for lenticular image 100, two digital images 106 associated with the respective categories 104 (i.e., continents and countries) may be selected. As illustrated in FIG. 8, one digital image 106 may comprise a map of the world illustrating the oceans and continents. As illustrated in FIG. 9, another digital image 106 may comprise a map of the world illustrating the countries within each continent. A viewer 212 may view a portion of each digital image 106 corresponding to a puzzle piece by, for example, tilting the puzzle piece back and forth. When the puzzle is completed, viewer 212 may also view each digital image 106 by tilting the entire puzzle.

The pieces of educational puzzle 800 may be shaped in any of a variety of desirable ways. In one embodiment, at least a portion of the puzzle pieces may be cut in the shape of the countries. It should be appreciated, however, that in alternative embodiments, at least a portion of the puzzle pieces may be cut in the shape of the continents, oceans, etc.

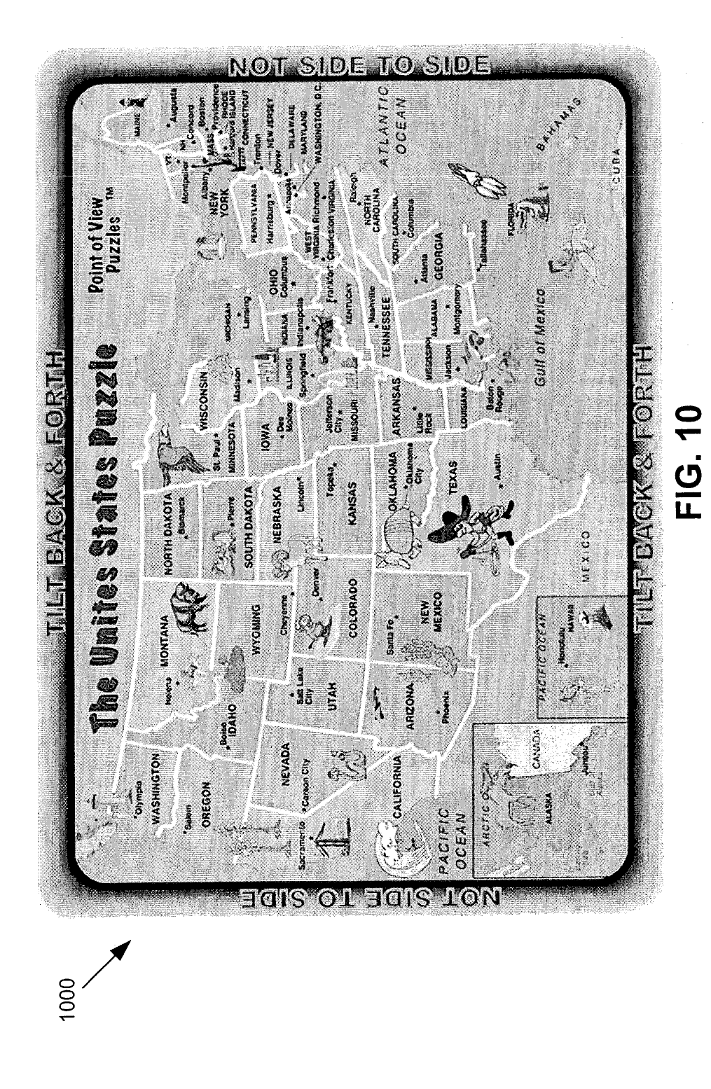

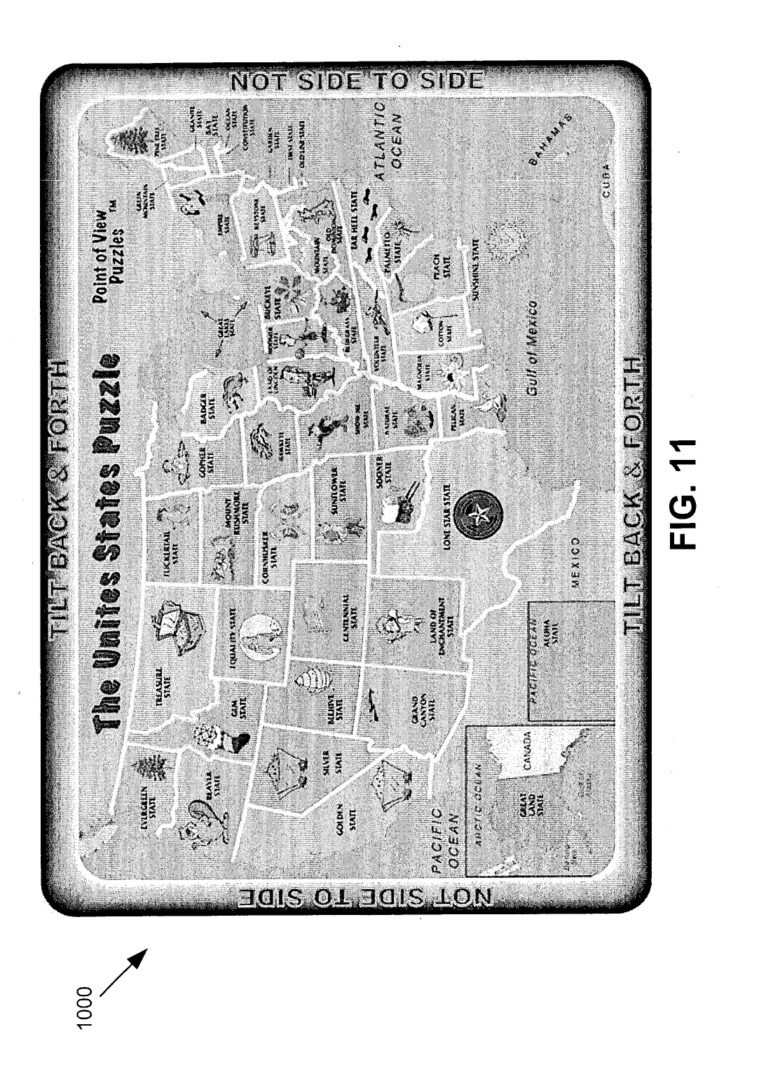

FIGS. 10 and 11 illustrate another embodiment of an educational puzzle 1000 according to the present invention. Educational puzzle 1000 may be configured as described above with respect to FIGS. 5-7, or in any other known manner. The lenticular image 100 implemented in educational puzzle 1000 may be designed to illustrate, convey, or teach an educational concept 102 related to U.S. geography. More specifically, lenticular image 100 may be designed to illustrate, convey, or teach the association between the states, state capitals, state nicknames, and various landmarks of interest (i.e., educational concept 102). As described above, given this design framework for lenticular image 100, two digital images 106 associated with the respective categories 104 may be selected. As illustrated in FIG. 10, one digital image 106 may comprise a map of the United States illustrating the state boundaries, state capitals, and various landmarks of interest. As illustrated in FIG. 11, another digital image 106 may comprise a map of the world illustrating the countries within each continent. A viewer 212 may view a portion of each digital image 106 corresponding to a puzzle piece by, for example, tilting the puzzle piece back and forth. When the puzzle is completed, viewer 212 may also view each digital image 106 by tilting the entire puzzle.

The pieces of educational puzzle 1000 may be shaped in any of a variety of desirable ways. For example, in one embodiment, at least a portion of the puzzle pieces may be cut in the shape of the states.

One of ordinary skill in the art will appreciate that, within the field of geography, digital images 106 may be designed to illustrate a variety of types of maps (e.g., political map, physical map, topographical map, relief map, etc.). Digital images 106 may also be designed to include other desirable information about the geographical region being illustrated (e.g., population data, topography, etc.).

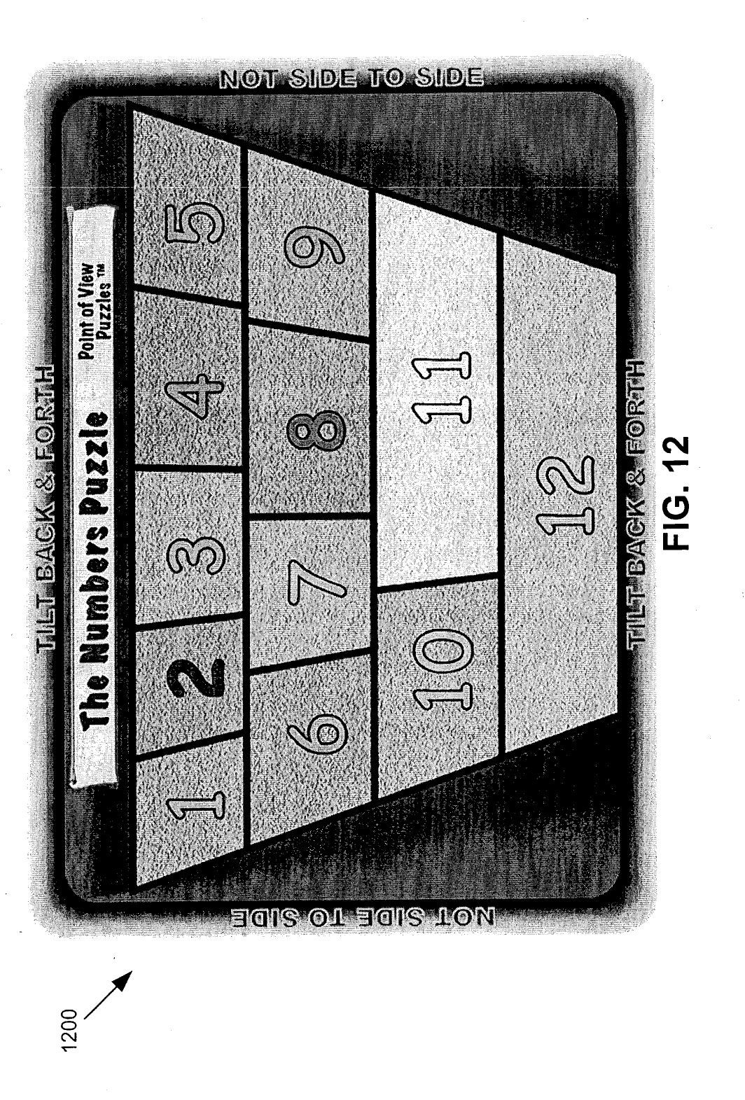

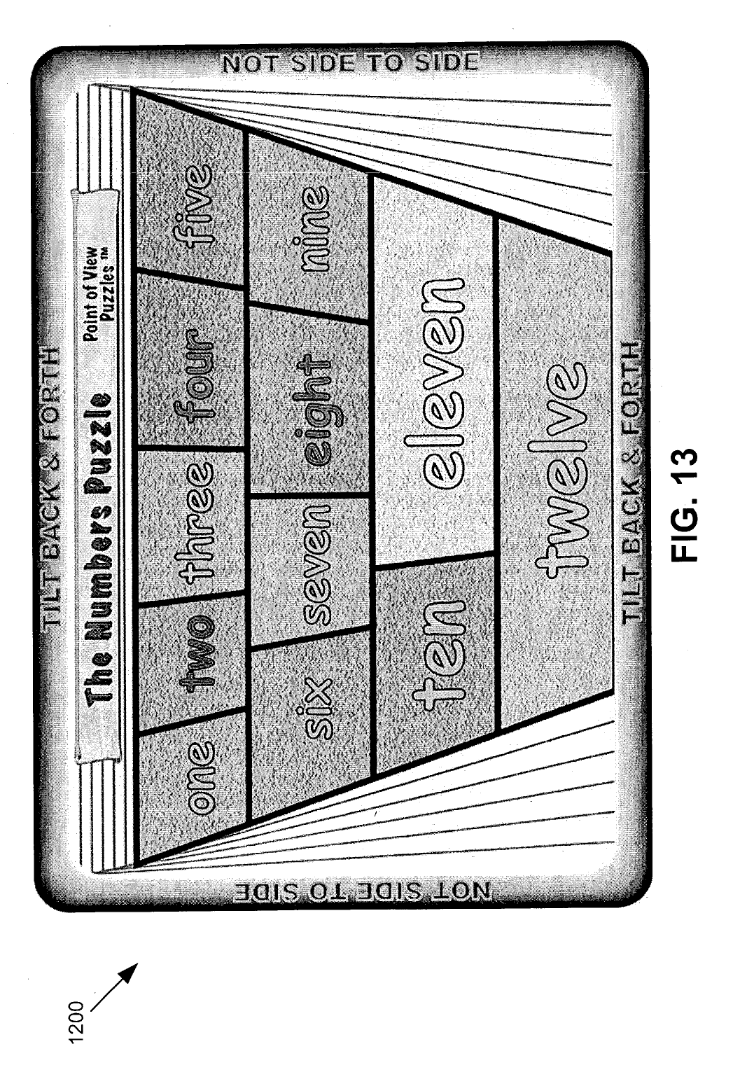

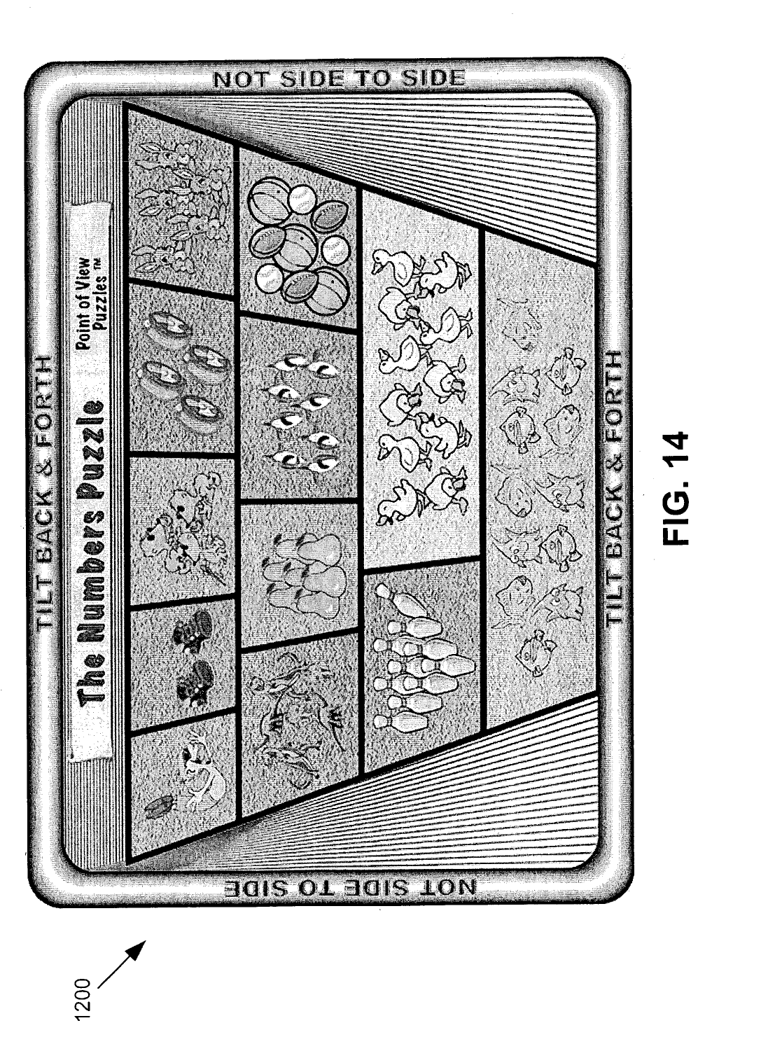

FIGS. 12-14 illustrate yet another embodiment of an educational puzzle 1200 according to the present invention. Educational puzzle 1200 may be configured as described above with respect to FIGS. 5-7, or in any other known manner. The lenticular image 100 implemented in educational puzzle 1200 may be designed to illustrate, convey, or teach the association between (1) numbers, (2) the spelling of the numbers, and (3) the quantity associated with the numbers (i.e., collectively, educational concept 102). In this regard, categories 104 may comprise (1) a number, (2) a word—spelling of the number, and (3) a quantity of objects associated with the number. Given this design framework for lenticular image 100, three digital images 106 associated with categories 104 may be selected. As illustrated in FIG. 12, one digital image 106 may illustrate the numerals 1-12. As illustrated in FIG. 13, another digital image 106 may include the spelling of each of the numerals. As illustrated in FIG. 14, a third digital image 106 may illustrate, for each numeral, a quantity of objects equal to the corresponding numeral. The pieces of educational puzzle 1200 may be shaped in any of a variety of desirable ways. For example, in one embodiment, it may be advantageous to include each numeral (and the corresponding spelling and quantity of objects) in a separate puzzle piece.

It should be emphasized that the above-described embodiments of the present invention, particularly, any “described” embodiments, are merely possible examples of implementations, merely set forth for a clear understanding of the principles of the invention. Many variations and modifications may be made to the above-described embodiment(s) of the invention without departing substantially from the spirit and principles of the invention. For example, it should be appreciated that lenticular image 100 may be created based on any number of digital images 106, to enable a viewer 212 to view any number of images. All such modifications and variations are intended to be included herein within the scope of this disclosure and the present invention and protected by the following claims.

Therefore, having thus described the invention, at least the following is claimed:

1. A teaching apparatus comprising:
a lenticular material having an array of lenticules with cylindrical lenses; and
a lenticular image associated with the lenticular material and designed to teach an educational concept, the lenticular image comprising a first image corresponding to a first category related to the educational concept and a second image corresponding to a second category related to the educational concept, the first and second categories selected such that relative movement between the teaching apparatus and a viewer enables the viewer to easily perceive the association between the first and second images and thereby learn the educational concept.

2. The teaching apparatus of claim 1, wherein the lenticular image is formed in an image layer that is integral with the lenticular material.

3. The teaching apparatus of claim 1, wherein the lenticular image is formed in a separate image layer that is joined to the lenticular material.

4. The teaching apparatus of claim 1, wherein the first image comprises a geographical map illustrating a first type of map and the second image comprises the geographical map illustrating a second type of map.

5. The teaching apparatus of claim 4, wherein the first type of map comprises a physical map and the second type of map comprises a political map.

6. The teaching apparatus of claim 4, wherein the first image comprises a map of the world illustrating the continents and the second image comprises a map of the world illustrating the countries in each continent.

7. The teaching apparatus of claim 6, wherein one of the first image and the second image further illustrates at least one of landmarks, topography, and population data.

8. The teaching apparatus of claim 1, wherein the first image comprises a first type of map illustrating the United States of America and the second image comprises a second type of map illustrating the United States of America.

9. The teaching apparatus of claim 8, wherein the first type of map illustrates state boundaries and the second type of map illustrates state capitals.

10. The teaching apparatus of claim 9, wherein one of the first type of map and the second type of map further illustrates at least one landmark.

11. The teaching apparatus of claim 9, wherein one of the first type of map and the second type of map further illustrates at least one of state nicknames, state capitals, topography, and population data.

12. The teaching apparatus of claim 1, wherein the first image comprises a map illustrating a first political view in history and the second image comprises the map illustrating a second political view in history.

13. The teaching apparatus of claim 1, wherein the first image illustrates at least one numeral and the second image contains the spelling of the at least one numeral.

14. The teaching apparatus of claim 13, wherein the lenticular image further comprises a third image that illustrates a quantity of objects, the quantity equal to the at least one numeral.

15. An educational puzzle comprising a plurality of puzzle pieces formed from a lenticular material having an array of lenticules with cylindrical lenses and a lenticular image associated with the lenticular material and designed to teach an educational concept, the lenticular image comprising a first image corresponding to a first category related to the educational concept and a second image corresponding to a second category related to the educational concept, the first and second categories selected such that relative movement between the teaching apparatus and a viewer enables the viewer to easily perceive the association between the first and second images and thereby learn the educational concept.

16. The educational puzzle of claim 15, further comprising a support frame for retaining the plurality of puzzle pieces.

17. The educational puzzle of claim 16, wherein the support frame comprises chipboard.

18. The educational puzzle of claim 16, wherein the support frame comprises a top sheet of chipboard affixed to a bottom sheet of chipboard at the respective outer peripheral edges and in which an interior portion of the top sheet has been cut and removed.

19. The educational puzzle of claim 15, wherein the lenticular image is formed in an image layer that is integral with the lenticular material.

20. The educational puzzle of claim 15, wherein the lenticular image is formed in a separate image layer that is joined to the lenticular material.

21. The educational puzzle of claim 15, wherein the first image comprises a geographical map illustrating a first type of map and the second image comprises the geographical map illustrating a second type of map.

22. The educational puzzle of claim 21, wherein the first type of map comprises a physical map and the second type of map comprises a political map.

23. The educational puzzle of claim 21, wherein the first image comprises a map of the world illustrating the continents and the second image comprises a map of the world illustrating the countries in each continent.

24. The educational puzzle of claim 23, wherein one of the first image and the second image further illustrates at least one of landmarks, topography, and population data.

25. The educational puzzle of claim 15, wherein the first image comprises a first type of map illustrating the United States of America and the second image comprises a second type of map illustrating the United States of America.

26. The educational puzzle of claim 25, wherein the first type of map illustrates state boundaries and the second type of map illustrates state capitals.

27. The educational puzzle of claim 26, wherein one of the first type of map and the second type of map further illustrates at least one landmark.

28. The educational puzzle of claim 26, wherein one of the first type of map and the second type of map further illustrates at least one of state nicknames, state capitals, topography, and population data.

29. The educational puzzle of claim 15, wherein the first image comprises a map illustrating a first political view in history and the second image comprises the map illustrating a second political view in history.

30. The educational puzzle of claim 15, wherein the first image illustrates at least one numeral and the second image contains the spelling of the at least one numeral.

31. The educational puzzle of claim 30, wherein the lenticular image further comprises a third image that illustrates a quantity of objects, the quantity equal to the at least one numeral.

32. A method of making an educational puzzle designed to teach an educational concept, the method comprising the steps of:
selecting a first image to include in a lenticular image, the first image corresponding to a first category related to an educational concept;
selecting a second image to include in the lenticular image, the second image associated with the first image and corresponding to a second category related to the educational concept; and
creating a lenticular assembly comprising a lenticular material having an array of lenticules with cylindrical lenses and a lenticular image based on the first image and the second image such that relative movement between the lenticular image and a viewer enables the viewer to easily perceive the association between the first and second images and thereby learn the educational concept.

33. The method of claim 32, further comprising the steps of:
mounting the lenticular assembly to a top sheet of chipboard;
affixing the top sheet of chipboard to a bottom sheet of chipboard at the respective outer peripheral edges; and
cutting an interior potion of the top sheet of chipboard within the outer peripheral edge to define a support frame and create a plurality of puzzle pieces.

34. The method of claim 32, wherein the step of creating the lenticular assembly comprises forming the lenticular image in an image layer that is integral with the lenticular material.

35. The method of claim 32, wherein the step of creating the lenticular assembly comprises forming the lenticular image in a separate image layer that is joined to the lenticular material.

36. The method of claim 32, wherein the step of selecting the first image comprises selecting a geographical map that illustrates a first type of map and the step of selecting the second image comprises selecting a second type of map for the geographical map.

37. The method of claim 36, wherein the first type of map comprises a physical map and the second type of map comprises a political map.

38. The method of claim 36, wherein the step of selecting a first image comprises selecting a map of the world that illustrates the continents and the step of selecting a second image comprises selecting a map of the world that illustrates the countries in each continent.

39. The method of claim 38, wherein one of the first image and the second image further illustrates at least one of landmarks, topography, population data.

40. The method of claim 32, wherein the step of selecting a first image comprises selecting a first type of map illustrating the United States of America and the step of selecting a second image comprises selecting a second type of map illustrating the United States of America.

41. The method of claim 40, wherein the first type of map illustrates state boundaries and the second type of map illustrates state capitals.

42. The method of claim 41, wherein one of the first type of map and the second type of map further illustrates at least one landmark.

43. The method of claim 41, wherein one of the first type of map and the second type of map further illustrates at least one of state nicknames, state capitals, topography, and population data.

44. The method of claim 32, wherein the step of selecting a first image comprises selecting a map that illustrates a first political view in history and the step of selecting a second image comprises selecting a second political view in history to illustrate on the map.

45. The method of claim 32, wherein the first image illustrates at least one numeral and the second image contains the spelling of the at least one numeral.

46. The method of claim 45, further comprising:
selecting a third image that illustrates a quantity of objects, the quantity equal to the at least one numeral; and
wherein the step of creating the lenticular image includes the third image.
